(19) United States
(12) Patent Application Publication
(10) Pub. No.: US 2017/0209969 A1
(43) Pub. Date: Jul. 27, 2017

(54) Lathe Chuck for Aluminum Alloy Hubs

(71) Applicant: CITIC Dicastal CO., LTD, Qinhuangdao (CN)

(72) Inventor: Jiandong Guo, Qinhuangdao (CN)

(73) Assignee: CITIC Dicastal CO., LTD, Qinhuangdao (CN)

(21) Appl. No.: 15/412,266

(22) Filed: Jan. 23, 2017

(30) Foreign Application Priority Data
Jan. 22, 2016 (CN) 201610040613.7

(51) Int. Cl. B23Q 3/06

(52) U.S. Cl. CPC B23Q 3/069; B23Q 3/062; B23Q 2703/10

(57) ABSTRACT

A lathe chuck for aluminum alloy hubs, which includes a pull rod shaft, a positioning unit fixing seat, a protective cover and a hollow shaft sleeve, wherein the upper cover and the chuck body are connected together by screws, forming a chuck main body; a mounting hole is formed in the bottom of the chuck body, so that the chuck is mounted on a machine tool; the positioning pins are mounted between the upper cover and the chuck body by screws; the pull rod shaft, a annular pressing plate and a tensioning plate are connected together by screws; the tensioning plate and the positioning pins form sliding fit by copper sleeves, and the positioning unit fixing seat, the protective cover and the hollow shaft sleeve are arranged together by screws to form a combination; the spring, the sliding blocks and the cuneiform taper sleeve are mounted in the combination.

### TECHNICAL FIELD

The present invention relates to a lathe chuck, and more particularly to a lathe chuck for aluminum alloy hubs.

### BACKGROUND ART

At present, a conventional machining process of an aluminum alloy hub generally comprises three working procedures, namely first-sequence lathe work, second-sequence lathe work and third-sequence drilling process, wherein the first-sequence lathe work is performed by the following steps of putting an aluminum alloy hub blank on a chuck, performing necessary positioning and clamping, and then performing lathe work according to a program on a numerical control lathe.

Because the blank is objectively influenced by preorder heat treatment deformation, metal processing allowance and different mold differences, in an alignment process of first-sequence blanks, positioning and clamping operations are particularly important. Therefore, compared with a fixture used for the second-sequence lathe work and a fixture used for the third-sequence drilling process, the structure of the chuck for the first-sequence lathe work is also more complex.

Particularly, in the processing course, if the blank is greatly deformed or molds are greatly different, requirements for the adaptability of the fixtures are high, and at this moment, the chuck is required to perform positioning and clamping within a large travel range.

In addition, according to a conventional processing mode, if products need to be exchanged, chucks of different specifications need to be replaced to adapt to different hub blanks. This not only wastes processing time, but also increases the workload of operators, thereby reducing the production yield.

### SUMMARY OF THE INVENTION

It is an object of the present invention to provide a lathe chuck for aluminum alloy hubs.

In order to realize the above object, the technical solution proposed by the present invention is that the lathe chuck for aluminum alloy hubs mainly comprises an upper cover, a chuck body, positioning pins, a tensioning plate, an annular pressing plate, a pull rod shaft, a positioning unit fixing seat, a protective cover, a hollow shaft sleeve, a cuneiform taper sleeve, a spring, sliding blocks, a lateral pull rod, step positioning blocks, a crank press claw, a connecting blind rivet and the like, wherein the upper cover and the chuck body are connected together by screws, forming a chuck main body; a mounting hole is formed in the bottom of the chuck body, so that the chuck is mounted on a machine tool; the positioning pins are mounted between the upper cover and the chuck body by screws; the pull rod shaft, the annular pressing plate and the tensioning plate are connected together by screws; the tensioning plate and the positioning pins form sliding fit by copper sleeves, and the positioning unit fixing seat, the protective cover and the hollow shaft sleeve are arranged together by screws to form a combination; the spring, the sliding blocks and the cuneiform taper sleeve are mounted in the combination, and when the cuneiform taper sleeve moves up and down, the sliding blocks can be driven to slide left and right; the sliding blocks are connected with the lateral pull rod by screws, and the step positioning blocks are driven by the lateral pull rod to slide left and right; the crank press claw is mounted on the upper cover by a pin shaft, and a ball head at the lower end of the crank press claw is inserted into a groove in the tensioning plate; the connecting blind rivet is used when the chuck is connected with the machine tool.

The cuneiform taper sleeve drives three sliding blocks to slide up and down at the same time, wherein each sliding block drives one step positioning block to travel along the radial direction.

Three step positioning blocks are provided and distributed uniformly on the upper cover of the chuck, and each of the step positioning blocks is provided with a high step and a low step that are used for allowing hub blanks of different diameters to be placed. The planes and the bevels of the steps of the step positioning blocks are consistent in dimensions and shapes, which play a role in performing end surface positioning and radial positioning on blanks, respectively.

The crank press claw is controlled by the tensioning plate, and when the hub blank is placed on the high steps of the step positioning blocks, the crank press claw is driven by the tensioning plate to swing and thus compact the blank; when the hub blank is placed on the low steps of the step positioning blocks, the travel range of the tensioning plate is extended, and the crank press claw is driven continuously to swing until the blank is compacted.

Before operation, the pull rod shaft drives the tensioning plate to the topmost end, and drives the crank pressing plate to open to the maximum extent. Besides, the tensioning plate tightly withstands the cuneiform taper sleeve, so that the spring is compressed, and the sliding blocks move upwards; the sliding blocks drive the lateral pull rod and the step positioning blocks to move outwards until they reach the outermost position, namely the position of the largest diameter.

During operation, in the placing process of an aluminum alloy hub blank, as each of the step positioning blocks is provided with steps of different heights, the blank will be placed on the high step if the blank diameter is large, and placed on the low step if the blank diameter is small. The outside end surface of the blank can be subjected to end surface positioning no matter which step the blank is placed at.

Then, the pull rod shaft drives the tensioning plate to move downwards, and the cuneiform taper sleeve also moves downwards under the action of the spring, and drives the sliding blocks to move towards the direction of the center of a circle; by virtue of the lateral pull rod, the sliding blocks also drive the step positioning blocks to move towards the center of a circle until the bevels of the step positioning blocks abut closely to the outer edge of the outer side of the blank, so that the blank can be radially positioned.

The pull rod shaft continuously drives the tensioning plate to move downwards, and the tensioning plate drives the crank press claw to deviate towards the inner side until a workpiece is compacted.

Up to this point, end surface positioning, radial positioning and compacting are performed on the aluminum alloy hub blank before processing, and subsequent lathe work can be performed.

The lathe chuck for aluminum alloy hubs disclosed by the present invention has the characteristics of stable and reliable clamping, good positioning consistency and stable operation, which is suitable for use by aluminum alloy hub machining lathes.

### BRIEF DESCRIPTION OF THE DRAWINGS

The present invention is further illustrated below in combination with the accompanying drawings and embodiments.

FIG. 1 is a front view of a lathe chuck for aluminum alloy hubs of the present invention.

FIG. 2 is a view of a lathe chuck for aluminum alloy hubs of the present invention when compacting a blank.

FIG. 3 is a view of a lathe chuck for aluminum alloy hubs of the present invention when clamping a blank with a small size.

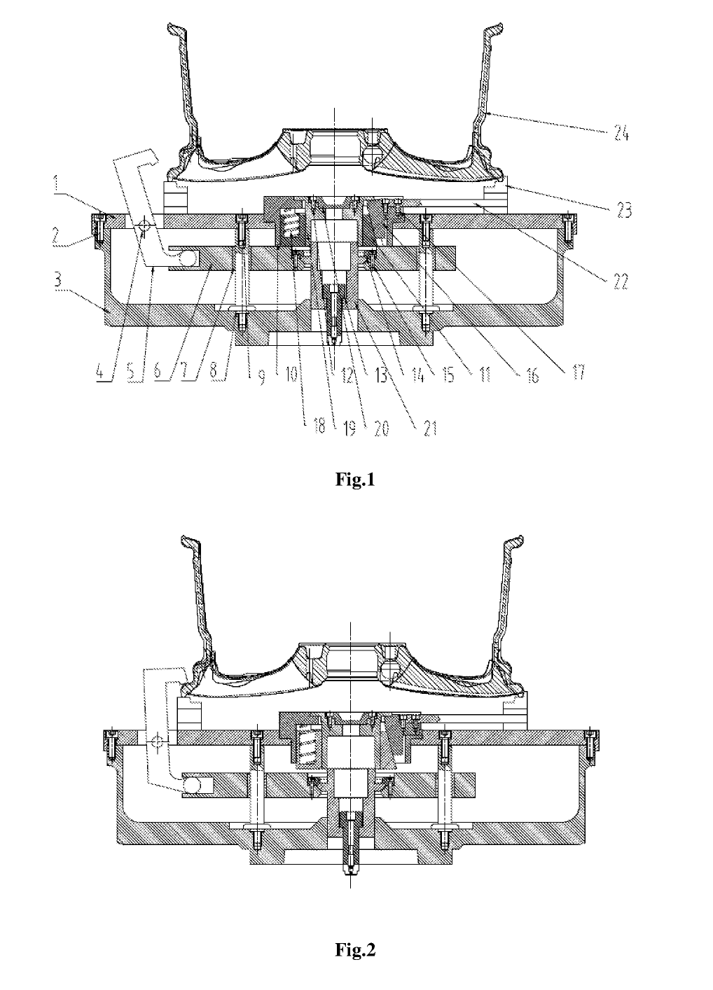

### DETAILED DESCRIPTION OF THE INVENTION

The details and working conditions of a specific device provided according to the present invention are described below in detail in combination with figures.

A lathe chuck for aluminum alloy hubs comprises an upper cover 1, a chuck body 3, positioning pins 8, a tensioning plate 6, an annular pressing plate 14, a pull rod shaft 21, a positioning unit fixing seat 10, a protective cover 20, a hollow shaft sleeve 19, a cuneiform taper sleeve 11, a spring 18, sliding blocks 16, a lateral pull rod 22, step positioning blocks 23, a crank press claw 5, a connecting blind rivet 13 and the like, wherein the upper cover 1 and the chuck body 3 are connected together by screws 2, forming a chuck main body; a mounting hole is formed in the bottom of the chuck main body, so that the chuck is mounted on a machine tool; the positioning pins 8 are mounted between the upper cover 1 and the chuck body 3 by screws 9; the pull rod shaft 21, the annular pressing plate 14 and the tensioning plate 6 are connected together by screws 15; the tensioning plate 6 and the positioning pins 8 form sliding fit by copper sleeves 7, and the positioning unit fixing seat 10, the protective cover 20 and the hollow shaft sleeve 19 are arranged together by screws 12 to form a combination; the spring 18, the sliding blocks 16 and the cuneiform taper sleeve 11 are mounted in the combination, and when the cuneiform taper sleeve 11 moves up and down, the sliding blocks 16 can be driven to slide left and right; the sliding blocks 16 are connected with the lateral pull rod 22 by screws 17, and the step positioning blocks 23 are driven by the lateral pull rod 22 to slide left and right; the crank press claw 5 is mounted on the upper cover 1 by a pin shaft 4, and a ball head at the lower end of the crank press claw 5 is inserted into a groove in the tensioning plate 6; the connecting blind rivet 13 is used when the chuck is connected with the machine tool.

The cuneiform taper sleeve 11 drives three sliding blocks 16 to slide up and down at the same time, wherein each sliding block 16 drives one step positioning block 23 to travel along the radial direction.

Three step positioning blocks 23 are provided and distributed uniformly on the upper cover 1 of the chuck, and each of the step positioning blocks 23 is provided with a high step and a low step that are used for allowing hub blanks of different diameters to be placed. The planes and the bevels of the steps of the step positioning blocks 23 are consistent in dimensions and shapes, which play a role in performing end surface positioning and radial positioning on blanks 24, respectively.

The crank press claw 5 is controlled by the tensioning plate 6, and when a hub blank is placed on the high steps of the step positioning blocks 23, the crank press claw 5 is driven by the tensioning plate 6 to swing and thus compact the blank; when the hub blank is placed on the low steps of the step positioning blocks 23, the travel range of the tensioning plate 6 is extended, and the crank press claw 5 is driven continuously to swing until the blank is compacted.

Before operation, the pull rod shaft 21 drives the tensioning plate 6 to the topmost end, and drives the crank pressing plate 5 to open to the maximum extent. Besides, the tensioning plate 6 tightly withstands the cuneiform taper sleeve 11, so that the spring 18 is compressed, and the sliding blocks 16 move upwards; the sliding blocks 16 drive the lateral pull rod 22 and the step positioning blocks 23 to move outwards until they reach the outermost position, namely the position of the largest diameter.

During operation, in the placing process of the aluminum alloy hub blank 24, as each of the step positioning blocks 23 is provided with steps of different heights, the blank will be placed on the high step if the blank diameter is large, and placed on the low step if the blank diameter is small. The outside end surface of the blank can be subjected to end surface positioning no matter which step the blank is placed at.

Then, the pull rod shaft 21 drives the tensioning plate 6 to move downwards, and the cuneiform taper sleeve 11 also moves downwards under the action of the spring 18, and drives the sliding blocks 16 to move towards the direction of the center of a circle; by virtue of the lateral pull rod 22, the sliding blocks 16 also drive the step positioning blocks 23 to move towards the center of a circle until the bevels of the step positioning blocks 23 abut closely to the outer edge of the outer side of the blank, so that the blank can be radially positioned.

The pull rod shaft 21 continuously drives the tensioning plate 6 to move downwards, and the tensioning plate 6 drives the crank press claw 5 to deviate towards the inner side until a workpiece is compacted.

Up to this point, end surface positioning, radial positioning and compacting are performed on the aluminum alloy hub blank before processing, and subsequent lathe work can be performed.

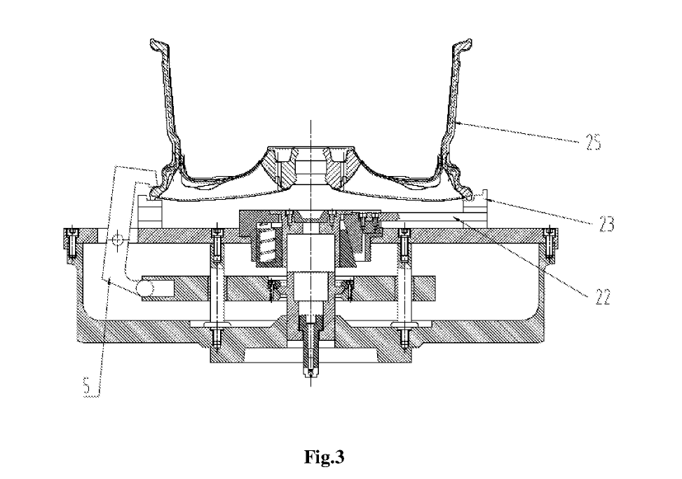

FIG. 3 shows the state of clamping the hub blank 25 with a small size, and at this moment, the moving distance of the step positioning blocks 23 towards the center of the chuck is larger, and the deflection angle of the crank press claw 5 is also larger.

1. A lathe chuck for aluminum alloy hubs, comprising:
an upper cover, a chuck body, positioning pins, a tensioning plate, an annular pressing plate, a pull rod shaft, a positioning unit fixing seat, a protective cover, a hollow shaft sleeve, a cuneiform taper sleeve, a spring, sliding blocks, a lateral pull rod, step positioning blocks, a crank press claw and a connecting blind rivet, and wherein the upper cover and the chuck body are connected together by screws, forming a chuck main body; a mounting hole is formed in the bottom of the chuck main body; the positioning pins are mounted between the upper cover and the chuck body by screws, the pull rod shaft, the annular pressing plate and the tensioning plate are connected together by screws, and the tensioning plate and the positioning pins form sliding fit by copper sleeves; the positioning unit fixing seat, the protective cover and the hollow shaft sleeve are arranged together by screws to form a combination, and the spring, the sliding blocks and the cuneiform taper sleeve are mounted in the combination; when the cuneiform taper sleeve moves up and down, the sliding blocks are driven to slide left and right; the sliding blocks are connected with the lateral pull rod by screws, and the step positioning blocks are driven by the lateral pull rod to slide left and right; the crank press claw is mounted on the upper cover by a pin shaft, and a ball head at the lower end of the crank press claw is inserted into a groove in the tensioning plate.

2. The lathe chuck for aluminum alloy hubs of claim 1, wherein three step positioning blocks are provided and distributed uniformly on the upper cover of the chuck body, each of the step positioning blocks is provided with a high step and a low step that are used for allowing hub blanks of different diameters to be placed, and planes and bevels of the steps of the step positioning blocks are consistent in dimensions and shapes, thereby performing end surface positioning and radial positioning on blanks.

3. The lathe chuck for aluminum alloy hubs of claim 1, wherein the crank press claw is controlled by the tensioning plate and driven by the tensioning plate to swing.
